(19) United States
(12) Patent Application Publication
(10) Pub. No.: US 2017/0266931 A1
(43) Pub. Date: Sep. 21, 2017

(54) OMNIPHOBIC MATERIALS FOR BIO-APPLICATIONS

(71) Applicants: Massachusetts Institute of Technology, Cambridge, MA (US); The Brigham and Women's Hospital, Inc., Boston, MA (US)

(72) Inventors: Robert S. Langer, Newton, MA (US); Carlo Giovanni Traverso, Newton, MA (US); Shiyi Zhang, Brookline, MA (US); Young-Ah Lucy Lee, Cambridge, MA (US)

(73) Assignees: Massachusetts Institute of Technology, Cambridge, MA (US); The Brigham and Women's Hospital, Inc., Boston, MA (US)

(21) Appl. No.: 15/465,304

(22) Filed: Mar. 21, 2017

Related U.S. Application Data
(60) Provisional application No. 62/311,193, filed on Mar. 21, 2016.

(51) Int. Cl. B32B 27/06; B32B 3/26

(52) U.S. Cl. CPC B32B 27/06; B32B 3/26; B32B 2535/00; B32B 2307/70

(57) ABSTRACT

Compositions and articles comprising omniphobic materials for bio-related and other applications are generally provided. In some embodiments, the compositions and articles described herein may be introduced internally of a subject (e.g., in the esophagus, in the gastrointestinal tract, in the rectum). In some aspects, the compositions and articles comprise a releasable therapeutic agent In some embodiments, the compositions and articles described herein may be configured to have a relatively short retention time at the location internal of the subject (e.g., less than 2 seconds) such as a capsule comprising an omniphobic coating. In alternative embodiments, the compositions and articles described herein may be configured to have relative long retention times at the location internal of the subject (e.g., greater than 10 minutes) and include a mucoadhesive portion as well as an omniphobic portion. Such articles may have an omniphobic portion which resists adhesion and/or fouling (e.g., by foodstuffs and/or other materials present internal of the subject) of the article, such that the mucoadhesive portion maintains adhesion to the location internal of the subject for relatively long retention times. In some such embodiments, the article may be a Janus-type device.

### RELATED APPLICATIONS

This application claims priority under 35 U.S.C. §119(e) to co-pending U.S. Provisional Application Ser. No. 62/311,193, filed Mar. 21, 2016, which is incorporated herein by reference in its entirety for all purposes.

### FEDERALLY SPONSORED RESEARCH

This invention was made with Government support under Grant No. R37 EB000244 awarded by the National Institutes of Health. The Government has certain rights in the invention.

### FIELD OF THE INVENTION

This invention generally relates to compositions and articles comprising omniphobic materials and related applications.

### BACKGROUND OF THE INVENTION

Mucoadhesives have been applied across a broad range of biomedical applications, from tissue engineering to medical implants and dosage formulations. However, mucoadhesive adhesion (e.g., to the gastrointestinal (GI) mucosal wall) can be significantly hindered by the continuous passage of foodstuffs and bodily fluids, leading to fouling and disruption of such systems. Accordingly, improved compositions and articles are needed.

### SUMMARY OF THE INVENTION

The present invention generally relates to compositions and articles comprising omniphobic materials. Certain of the compositions described herein include a therapeutic agent.

In one aspect, articles for introduction internally of a subject, the article constructed and arranged for introduction into and residence internally of the subject, or to exhibit a physiological surface retention time of less than 2 seconds, are provided. In some embodiments, the article comprises an omniphobic portion for resisting adhesion, to the device, of material internally of the subject.

In another aspect, articles for introduction to and residence internally of a subject with resistance to adhesion and/or fouling, to the article, of material internally of the subject, are provided. In some embodiments, the article comprises a mucoadhesive portion for inhibition of mobility of the device internally of the subject, and a omniphobic portion for resisting adhesion and/or fouling, to the device, of material internally of the subject.

In some embodiments, the article comprises a non-omniphobic portion and/or cavity at least partially encapsulated by an omniphobic portion, wherein the omniphobic portion comprises a polymer having a microtextured surface and a lubricant disposed on at least a portion of the microtextured surface.

In yet another aspect, methods of administering an article constructed and arranged for introduction into and residence internally of the subject, or to exhibit a physiological surface retention time of less than 2 seconds, are provided. In some embodiments, the method comprises administering, to the subject, the article comprising an omniphobic portion for resisting adhesion, to the article, of material internally of the subject.

Other advantages and novel features of the present invention will become apparent from the following detailed description of various non-limiting embodiments of the invention when considered in conjunction with the accompanying figures. In cases where the present specification and a document Incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of an article comprising an omniphobic portion, according to some embodiments;

FIG. 2 is a schematic illustration of an article comprising an omniphobic portion, according to some embodiments;

FIG. 3 is a schematic illustration of an article comprising an omniphobic portion, according to some embodiments;

FIG. 4A is a schematic illustration of a non-Janus device with an adhesive surface on both sides, showing fouling and dislodgement (indicated by the arrow), according to one set of embodiments;

FIG. 4B is a Janus device having an omniphobic portion and a mucoadhesive portion, with arrows representing the flow direction of foodstuffs and other bodily fluids, according to one set of embodiments;

FIG. 5A is a fabrication process scheme of a Janus device, according to one set of embodiments;

FIG. 5B are SEM images for surface roughening/texturing: top, low and high magnification of the microposts on the natural lotus leaf surface; middle, low and high magnification of the microwells on the patterned PDMS master mold surface; and bottom, low and high magnification of the replicated microposts on the patterned cellulose acetate (CA) surface, according to one set of embodiments;

FIG. 5C show contact angle measurements (mean ±s.d., n=8): top, planar CA surface, middle, patterned CA surface with replicated microposts and bottom, omniphobic CA surface with fluorinated and lubricated microposts, using different liquids (water, hexane, and vegetable oil), according to one set of embodiments;

FIG. 5D shows exemplary photographs from retention time tests using porcine intestinal mucosa and various modified surfaces: (from left to right) planar CA, patterned CA with microposts, fluorinated patterned CA, omniphobic patterned CA, and adhesive Carbopol®, according to one set of embodiments;

FIG. 6A shows exemplary microscopy images of fluorescently-labeled BSA adsorption on various modified surfaces: (from left to right) planar CA, patterned CA with microposts, fluorinated patterned CA, omniphobic patterned CA, and adhesive Carbopol®, according to one set of embodiments;

FIG. 6B shows quantitative fluorescence intensities for the corresponding modified surfaces in FIG. 6A, according to one set of embodiments;

FIG. 6C is a schematic representation and photograph of the experimental setup for measuring retention time, according to one set of embodiments;

FIG. 6D is a plot of the mean values and standard deviations of the retention times (“A” denotes adhesive and “O” denotes omniphobic (i.e. A|O is adhesive on one side and omniphobic on the other)), according to one set of embodiments;

FIG. 6E show time-lapse photography from an exemplary retention test, according to one set of embodiments (the series of the bi-colored arrows traces the retention of the A|O Janus device and the series of arrows traces the dislodgement of the A|A non-Janus device, according to one set of embodiments);

FIG. 6F shows photographs demonstrating no fouling on both devices before the flow (right, a snapshot of no fouling on A|O Janus device (on the left with foodstuffs not adhered) versus fouling on A|A non-Janus device (on the right with foodstuffs adhered)), according to one set of embodiments;

FIG. 7 are SEM images of the nanotexturing on the replicated CA surface from the lotus leaf based PDMS mold, according to one set of embodiments

FIG. 8 shows contact angle measurements for the surface texturing step: top, natural lotus leaf, middle, patterned PDMS surface compared to control flat PDMS surface, and bottom, patterned CA surface compared to control flat CA surface, according to one set of embodiments;

FIG. 9 shows contact angle measurements of surfaces using different liquids of water, hexane, vegetable oil, ethanol, and toluene: (from top to bottom) planar CA, patterned CA with microposts, fluorinated CA with microposts, omniphobic CA with fluorinated and lubricated microposts, adhesive Carbopol®, and natural lotus leaf, according to one set of embodiments;

FIG. 10 shows an exemplary time-lapse photography from the retention time tests using porcine intestinal mucosa with five modified surfaces: (from top to bottom) planar CA, patterned CA with microposts, fluorinated CA with microposts, omniphobic CA with fluorinated and lubricated microposts, and adhesive wetted Carbopol®, according to one set of embodiments;

FIG. 11 shows IR spectroscopy of five modified surfaces: (from top to bottom) planar CA, patterned CA with microposts, fluorinated CA with microposts, omniphobic CA with fluorinated and lubricated microposts, and adhesive Carbopol®, according to one set of embodiments;

FIG. 12 shows plots of XPS analysis including survey spectra and atomic concentration ratios of the modified surfaces: planar CA, patterned CA with microposts, fluorinated CA with microposts, and adhesive Carbopol®, according to one set of embodiments; and

FIG. 13 shows exemplary SEM images of: left, initial planar CA side compared to the fabricated omniphobic portion via surface morphogical and chemical modifications and right, initial planar Carbopol® side compared to the fabricated adhesive layer via wetting, according to one set of embodiments.

### DETAILED DESCRIPTION OF THE INVENTION

Compositions and articles comprising omniphobic materials for bio-related and other applications are generally provided. In some embodiments, the compositions and articles described herein may be introduced internally of a subject (e.g., in the esophagus, in the gastrointestinal tract, in the rectum, orally). In some aspects, the compositions and articles comprise a releasable therapeutic agent In some embodiments, the compositions and articles described herein may be configured to have a relatively short retention time at the location internal of the subject (e.g., less than 2 seconds) such as a capsule comprising an omniphobic coating. In alternative embodiments, the compositions and articles described herein may be configured to have relative long retention times at the location internal of the subject (e.g., greater than 10 minutes) and include a mucoadhesive portion as well as an omniphobic portion. Such articles may have an omniphobic portion which resists adhesion and/or fouling (e.g., by foodstuffs and/or other materials present internal of the subject) of the article, such that the mucoadhesive portion maintains adhesion to the location internal of the subject for relatively long retention times. In some such embodiments, the article may be a Janus-type device. Janus-type devices are generally devices wherein the device is divided into two distinct portions comprising two different components. For example, in some cases, the article comprises a mucoadhesive portion having a mucoadhesive surface and an omniphobic portion having an omniphobic surface, opposite and adjacent (e.g., directly adjacent) the mucoadhesive portion.

Advantageously, the compositions and articles described herein, when located internal of a subject, provide repulsion of materials (e.g., food) and fluids (e.g., bodily fluids) by a luminal-facing omniphobic surface and, in some embodiments, reinforces attachment to the surface of the location internal of the subject by the mucoadhesive side. As compared to traditional mucoadhesive compositions, the compositions and articles described herein have increased retention times (e.g., and enabling prolonged drug release and/or dose frequency minimization by the device) and reduced fouling. Compositions and/or articles comprising the omniphobic portion, but no mucoadhesive portion, may advantageously prevent the adhesion of the composition or article to a location internal of the subject. For example, in some cases a capsule comprising an omniphobic coating may have significantly reduced retention times as compared to traditional capsules (e.g., for oral or rectal drug and/or medical device delivery). Such compositions and articles may reduce or prevent complications associated with oral delivery of drug-containing capsule including, for example, as a result of esophagitis (e.g., wherein a capsule introduced into the esophagus of a subject adheres to a surface of the esophagus).

The compositions and articles described herein may be useful for a variety of applications, including drug delivery, biological diagnostics, medical devices, tissue engineering, veterinary applications, food packaging and environmental engineering applications, as described in more detail below.

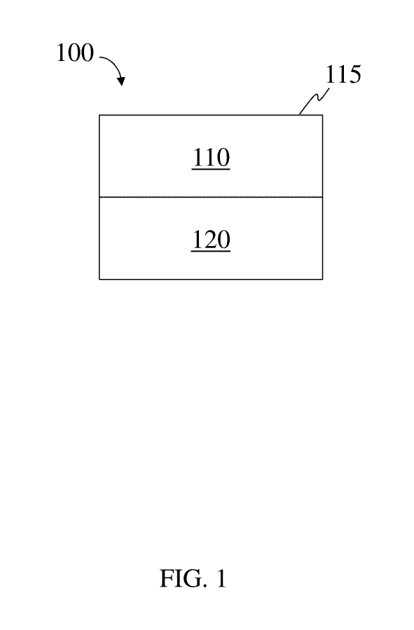

In some embodiments, the article comprises an omniphobic portion and a non-omniphobic portion. As illustrated in FIG. 1, in some embodiments, article 100 comprises omniphobic portion 110 and a non-omniphobic portion 120 directly adjacent the omniphobic portion. In certain embodiments, omniphobic portion 110 comprises at least one omniphobic surface 115. In some cases, the non-omniphobic portion comprises a polymer comprising a therapeutic agent. In some embodiments, the non-omniphobic portion is a mucoadhesive portion (e.g., comprising a mucoadhesive material). In some such embodiments, the article may comprise one or more additional non-omniphobic portions disposed between the omniphobic portion and the mucoadhesive portion.

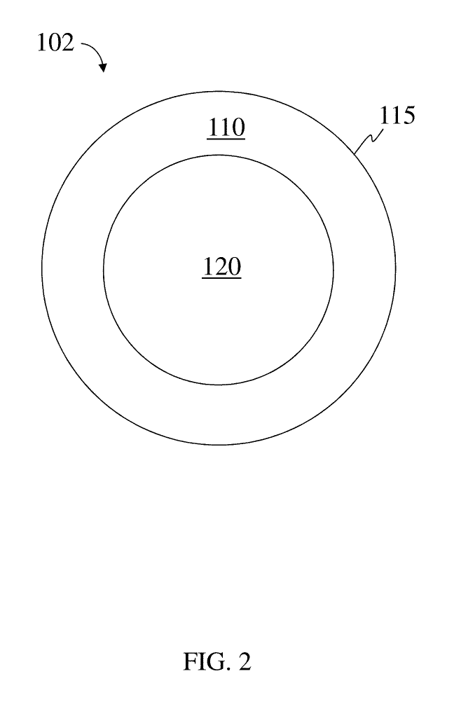

In certain embodiments, the article comprises an omniphobic portion at least partially encapsulating a non-omniphobic portion. For example, as illustrated in FIG. 2, in some embodiments article 102 comprises omniphobic portion 110 encapsulating non-omniphobic portion 120. In some such embodiments, the non-omniphobic portion may comprise a cavity (e.g., a cavity configured and arrange to receive and/or contains a liquid and/or a solid such as a therapeutic agent). In an exemplary embodiment, the non-omniphobic portion is a capsule (e.g., a capsule comprising a therapeutic agent and/or a medical device contained therein). In some embodiments, the omniphobic portion may be a coating on the capsule (e.g., such that the capsule does not substantially adhere and/or has a retention time of less than 2 seconds internal of a subject).

In some embodiments, the omniphobic portion comprises a surface having at least hydrophobic and oleophobic properties. In certain embodiments, the omniphobic portion repels wetting by two or more types of liquids (e.g., polar liquids, non-polar liquids). In some cases, the omniphobic portion may reduce and/or prevent biofouling including reduced adsorption of proteins.

In some embodiments, the omniphobic portion comprises at least a surface having particular wettability properties. In certain embodiments, the omniphobic portion comprises at least a surface having a contact angle of at least 90 degrees with a droplet of water and at least two or more of: a contact angle of at least 40 degrees with a droplet of vegetable oil, a contact angle of at least 30 degrees with a droplet of hexane, a contact angle of at least 30 degrees with a droplet of ethanol, and a contact angle of at least 40 degrees with a droplet of toluene, as measured using goniometry.

In some embodiments, the non-omniphobic portion comprises a hydrophobic surface (e.g., having a contact angle of at least 90 degrees with a droplet of water) but does not comprise an oleophobic surface (e.g., having a contact angle of at least 40 degrees with a droplet of vegetable oil). In certain embodiments, the non-omniphobic portion is oleophobic but not hydrophobic. In some cases, the non-omniphobic portion may be neither hydrophobic nor oleophobic.

In some embodiments, the omniphobic portion may be molded and/or fabricated to have a particular texture (e.g., microtextured and/or nanotextured). For example, in some embodiments, the omniphobic portion may have at least a surface that is rough and/or has particular features which offers advantageous properties as compared to other ingestible materials. For example, an article described herein having a microtextured and/or nanotextured may have reduced retention times as compared to ingestible materials that are not textured. In some embodiments, the microtexture and/or nanotexture may increase the hydrophobicity of the surface as compared to an untextured surface (e.g., having the otherwise same material composition and properties).

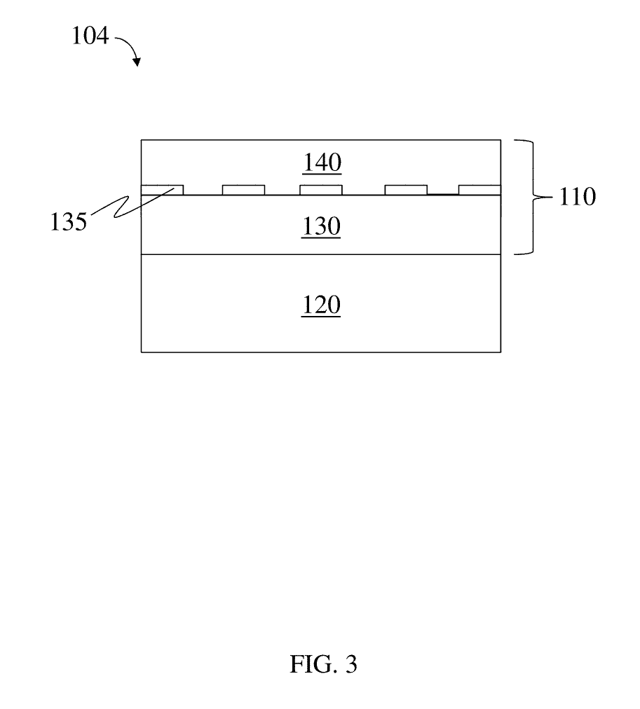

As illustrated in FIG. 3, article 104 comprises a non-omniphobic portion 120 and a omniphobic portion 110. Omniphobic portion 110 comprises a first material 130 (e.g., a polymeric material) comprising textured surface 135.

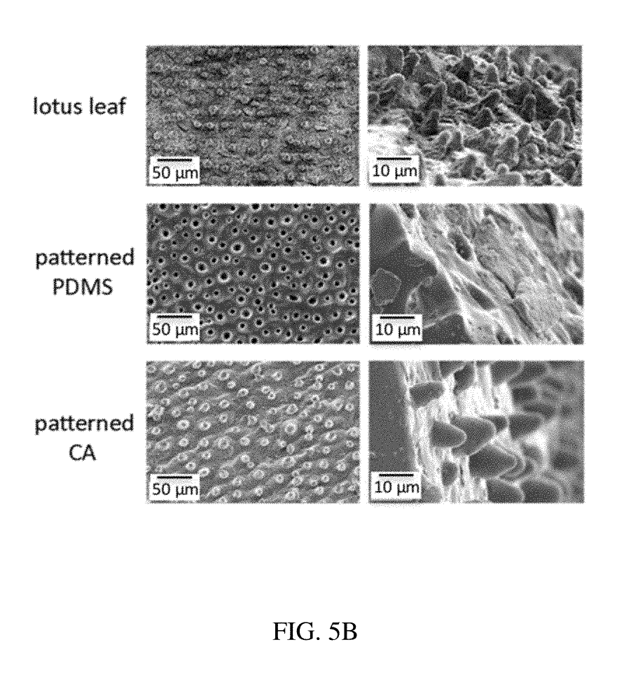

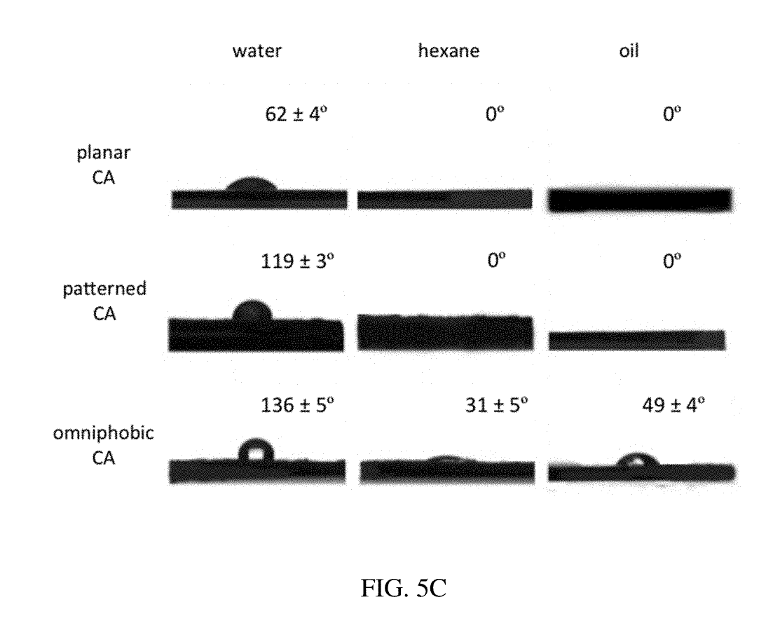

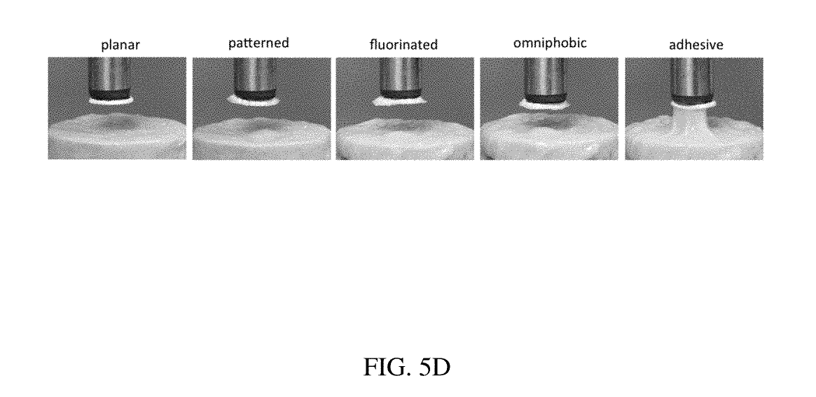

In some embodiments, the microtexture and/or nanotexture comprises particular features. Non-limiting microtexture and/or nanotexture features include, for example, posts, ridges, grooves, holes, spheres, cubes, mounds, and anisotropic shapes. In a particular embodiment, at least a surface of the omniphobic portion comprises a lotus leaf microtexture. Lotus leaf microtextures are generally known in the art. An exemplary SEM image of a lotus leaf microtexture is shown in FIG. 5B.

In certain embodiments, the microtexture and/or nanotexture features may be arranged to form a particular pattern (e.g., simple, checkerboard, honeycomb, cubic, hexagonal, polygonal) on at least a surface of the omniphobic portion. In certain embodiments, the microtexture and/or nanotexture pattern may be regular across the omniphobic portion. In other embodiments, the microtexture and/or nanotexture pattern may be irregular and/or may vary based on a certain factors, such as location in the omniphobic portion or the pattern of the textured features. In general, any suitable pattern can be used to achieve the desired properties (e.g., wettability). It should be noted, however, that the microtexture and/or nanotexture features may not have a defined pattern and/or periodicity in some embodiments.

Those skilled in the art would be capable of selecting suitable methods for texturing the surface of a material including, for example, the use of a master mold (e.g., polydimethylsiloxane comprising a negative image of the texture) and transferring the texture via soft lithography. Other methods for texturing the surface are also possible.

In some embodiments, the texture of at least a surface of the omniphobic portion may be such that it changes (e.g., increases, decreases) the wettability of the composition and/or article to a fluid (e.g., water, vegetable oil, hexane, toluene, ethanol). Wettability of a rough and/or textured surface with respect to a particular fluid may be determined, in some cases, by measuring the contact angle of a droplet of the fluid with the surface of the omniphobic portion via goniometry.

In certain embodiments, the omniphobic portion may be textured such that at least a surface of the omniphobic portion is at least hydrophobic. In some embodiments, the contact angle of a droplet of water with the textured surface of the omniphobic portion may be at least about 90 degrees, at least about 95 degrees, at least about 100 degrees, at least about 110 degrees, at least about 120 degrees, or at least about 130 degrees. In certain embodiments, the contact angle of a droplet of water with the textured surface of the omniphobic portion is less than or equal to about 140 degrees, less than or equal to about 130 degrees, less than or equal to about 120 degrees, less than or equal to about 110 degrees, less than or equal to about 100 degrees, or less than or equal to about 95 degrees. Combinations of the above-referenced ranges are also possible (e.g., at least about 90 degrees and less than or equal to about 140 degrees). Other ranges are also possible.

In some embodiments, may be textured such that at least a surface of the omniphobic portion has the contact angle between a droplet of vegetable oil with the textured surface of the omniphobic portion of at least about 40 degrees, at least about 45 degrees, at least about 50 degrees, at least about 60 degrees, at least about 70 degrees, at least about 80 degrees, at least about 90 degrees, or at least about 100 degrees. In certain embodiments, the contact angle of a droplet of vegetable oil with the textured surface of the omniphobic portion is less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, or less than or equal to about 45 degrees. Combinations of the above-referenced ranges are also possible (e.g., at least about 40 degrees and less than or equal to about 110 degrees). Other ranges are also possible.

In certain embodiments, may be textured such that at least a surface of the omniphobic portion has the contact angle between a droplet of toluene with the textured surface of the omniphobic portion of at least about 40 degrees, at least about 45 degrees, at least about 50 degrees, at least about 60 degrees, at least about 70 degrees, at least about 80 degrees, at least about 90 degrees, or at least about 100 degrees. In certain embodiments, the contact angle of a droplet of toluene with the textured surface of the omniphobic portion is less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, or less than or equal to about 45 degrees. Combinations of the above-referenced ranges are also possible (e.g., at least about 40 degrees and less than or equal to about 110 degrees). Other ranges are also possible.

In some embodiments, may be textured such that at least a surface of the omniphobic portion has the contact angle between a droplet of hexane with the textured surface of the omniphobic portion of at least about 30 degrees, at least about 40 degrees, at least about 45 degrees, at least about 50 degrees, at least about 60 degrees, at least about 70 degrees, at least about 80 degrees, at least about 90 degrees, or at least about 100 degrees. In certain embodiments, the contact angle of a droplet of hexane with the textured surface of the omniphobic portion is less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, or less than or equal to about 40 degrees. Combinations of the above-referenced ranges are also possible (e.g., at least about 30 degrees and less than or equal to about 110 degrees). Other ranges are also possible.

In some embodiments, may be textured such that at least a surface of the omniphobic portion has the contact angle between a droplet of ethanol with the textured surface of the omniphobic portion of at least about 30 degrees, at least about 40 degrees, at least about 45 degrees, at least about 50 degrees, at least about 60 degrees, at least about 70 degrees, at least about 80 degrees, at least about 90 degrees, or at least about 100 degrees. In certain embodiments, the contact angle of a droplet of ethanol with the textured surface of the omniphobic portion is less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, or less than or equal to about 40 degrees. Combinations of the above-referenced ranges are also possible (e.g., at least about 30 degrees and less than or equal to about 110 degrees). Other ranges are also possible.

The omniphobic portion may comprise any suitable material. In some embodiments, the omniphobic portion comprises a biocompatible material. The term “biocompatible,” as used herein, refers to a polymer that does not invoke an adverse reaction (e.g., immune response) from an organism (e.g., a mammal), a tissue culture or a collection of cells, or if the adverse reaction does not exceed an acceptable level.

In some embodiments, the omniphobic portion comprises polymers, their networks, and/or multi-block combinations of, for example, such as cellulose esters including, but not limited to, cellulose acetate, cellulose acetate butyrate, cellulose acetate phthalate, and hydroxypropyl methyl cellulose; polyesters, including but not limited to, polycaprolactone, poly(propylene fumarate), poly(glycerol sebacate), poly(lactide), poly(glycol acid), poly(lactic-glycolic acid), polybutyrate, and polyhydroxyalkanoate; polyethers, including but not limited to, poly(ethylene oxide) and poly(propylene oxide); polysiloxanes, including but not limited to, poly(dimethylsiloxane); polyamides, including but not limited to, poly(caprolactam); polyolefins, including but not limited to, polyethylene; polycarbonates, including but not limited to poly(propylene oxide); polyketals; polyvinyl alcohols; polyoxetanes; polyacrylates/methacrylates, including but not limited to, poly(methyl methacrylate) and poly(ethyl-vinyl acetate); polyanhydrides; and polyurethanes. In some embodiments, the polymer is cross-linked. In some embodiments, the omniphobic portion comprises a polymer composite comprising two or more chemically similar polymers or two or more chemically distinct polymers. In certain embodiments, the omniphobic portion comprises gelatin. In some cases, the omniphobic portion may comprise a carbohydrate such as a polysaccharide (e.g., cellulose, starch, glycogen).

In some embodiments, the omniphobic portion comprises an enteric polymer including, but not limited to, cellulose acetate phthalate (CAP), hypromellose (INN) or hydroxypropyl methylcellulose (HPMC), and EUDRAGIT® (available from Evonik Industries AG (Essen, Germany)).

In some embodiments, at least a surface of the omniphobic portion (e.g., the microtextured and/or the nanotextured surface) may be fluorinated. The fluorination of the surface of the omniphobic portion may impart desirable properties including, for example, omniphobicity and/or to facilitate subsequent lubrication through chemical affinity.

In certain embodiments, the surface of the omniphobic portion may be functionalized such that at least a portion of the surface is fluorinated. For example, in some embodiments, the surface of the omniphobic portion may be functionalized via vapor-phase fluorination with a perfluorinated silane such as heptadecafluoro-1,1,2,2-tetrahydrodecyl trichlorosilane. Other perfluorinated silanes are also possible.

In some embodiments, a lubricant (e.g., a perfluorocarbon lubricant) may be deposited on the surface of the omniphobic portion. The lubrication of the surface of the omniphobic portion may impart desirable properties including, for example, omniphobicity of the surface. In some embodiments, the microtextured and/or nanotextured surface of the omniphobic portion may be fluorinated and/or coated with a lubricant. Referring again to FIG. 3, in some embodiments, lubricant 140 may be deposited on textured surface 135. In some embodiments, the wettability's described above are imparted on the omniphobic portion upon lubrication of the textured surface.

Non-limiting examples of suitable lubricants include perfluorocarbon compounds such as perfluoroalkanes (e.g., perfluorohexanes, perfluorooctane, perfluorodecalin, perfluoromethylcyclohexane), perfluoroalkenes (e.g., perfluorobenzene), perfluoroalkynes, and branched fluorocarbons (e.g., perfluorotributylamine). Other perfluorocarbons are also possible.

As described above, in some embodiments, at least a surface of the omniphobic portion resists adhesion and/or fouling to the surface. For example, in certain embodiments, an article comprises the omniphobic portion may resist adhesion and/or fouling, to the article, of material internally of the subject.

In some embodiments, the omniphobic portion may have a particular retention time. That is to say, in some embodiments, the omniphobic portion may adhere to a substrate (e.g., a surface of tissue located internal to a subject) for a relatively short amount of time. In certain embodiments, an article comprising an omniphobic portion at least partially encapsulating a non-omniphobic portion may have a relatively small retention time. In some embodiments, the retention time of the omniphobic portion (or an article comprising an omniphobic portion at least partially encapsulating a non-omniphobic portion) is less than 5 seconds, less than 3 seconds, less than 2 seconds, less than 1 second, or less than 0.5 seconds. In certain embodiments, the retention time of the omniphobic portion is greater than or equal to 0.1 seconds, greater than or equal to 0.5 seconds, greater than or equal to 1 second, greater than or equal to 2 seconds, greater than or equal to seconds, or greater than or equal to 3 seconds. Combinations of the above-referenced ranges are also possible (e.g., less than 5 seconds and greater than or equal to 0.1 seconds, less than 2 seconds and greater than or equal to 0.1 seconds). Other ranges are also possible. In some embodiments, the omniphobic portion has substantially no retention time (e.g., a retention time of about 0 seconds).

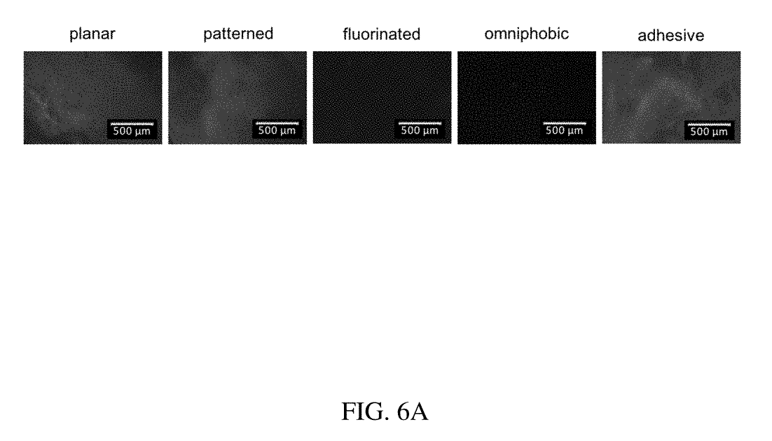

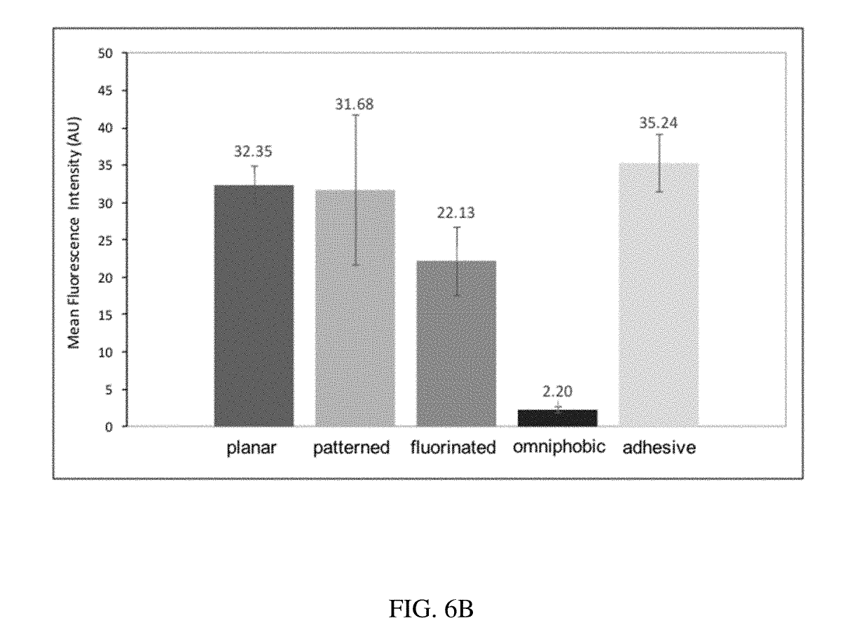

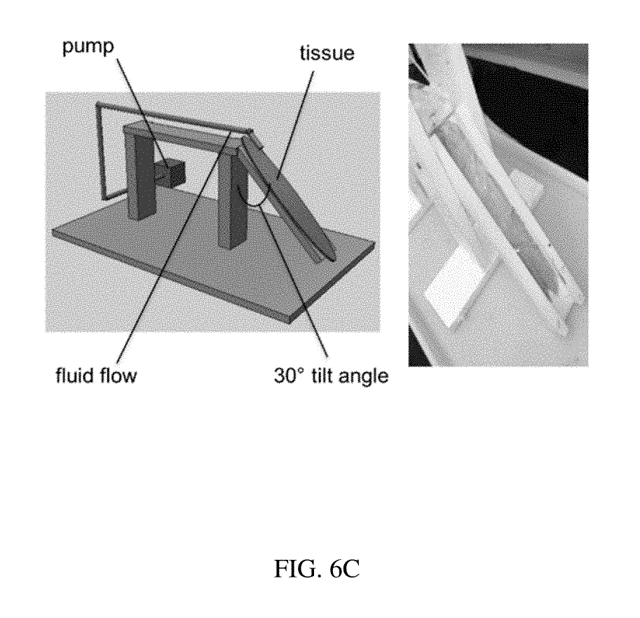

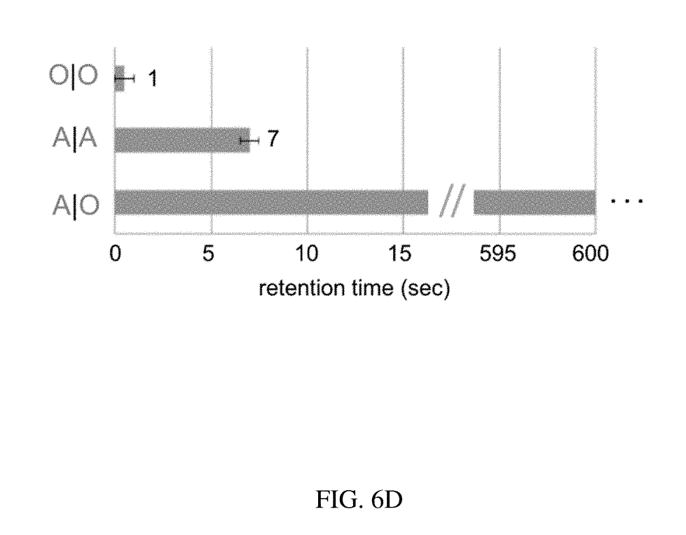

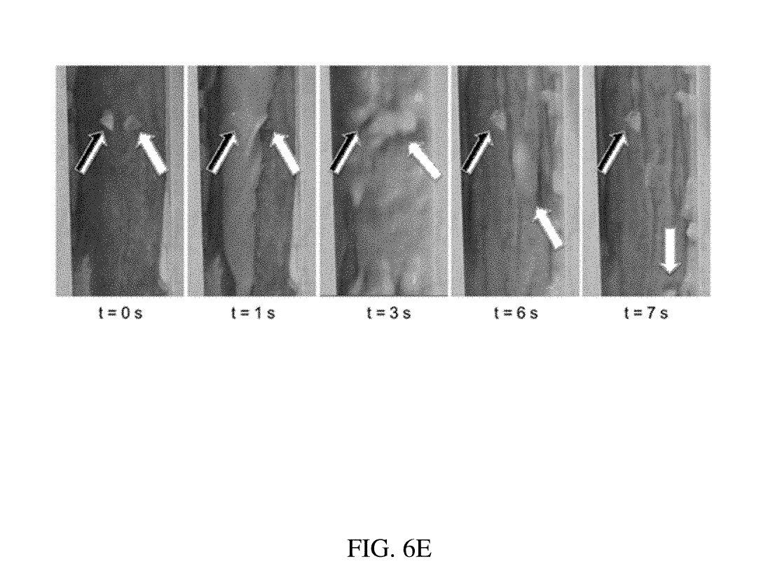

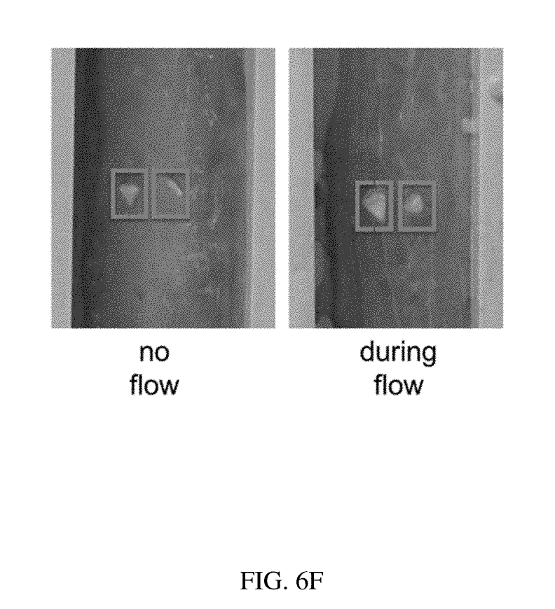

Retention time, as described herein, may be determined by measuring the amount of time until an article detaches from a surface of a segment of porcine intestinal tissue. Excised fixed mucosal porcine intestinal tissues cut into a length of 30 cm and opened to line the angled side of the test apparatus are used for the retention time test, as shown in FIG. 6C. An article as described herein is placed at an initial location on the tissue, 22 cm from the bottom of the angled side of the apparatus, and incubated at room temperature for 30 seconds. The apparatus may be turned upside down to determine if the article had adhered, and then the apparatus should be returned at a tilt angle of 30°. At room temperature, the fixed mucosal intestinal tissue and adhered article is continuously flushed with simulated fed-state fluid at 850 mL min⁻¹. The simulated fluid consists of fed-state simulated intestinal fluid (FeSSIF, pH ˜6.8) and EnsurePlus (pH ˜6.6) in a ratio of 1:4 with foodstuffs (15 g/L of bread pieces and 50 g/L of rice) mixed in. The retention time is the amount of time that elapses between starting the flushing of the simulated fed-state fluid over the article until dislodgement of the article from the initial location on the tissue.

As described herein, in some embodiments, the article comprises an omniphobic portion and a non-omniphobic portion. The non-omniphonic portion may comprise any suitable material including, but not limited to, polymers (e.g., biodegradable polymers, biocompatible polymers, silicone), metals (e.g., nickel, copper, stainless steel, bulk metallic glass, or other metals or alloys), ceramics (e.g., glass, quartz, silica, alumina, zirconia, tungsten carbide, silicon carbide), graphite, and silicon.

In a particular embodiment, the non-omniphobic portion is a mucoadhesive portion comprising a mucoadhesive material. For example, referring again to FIG. 1, non-omniphobic portion 120 may be a mucoadhesive portion. Mucoadhesive portions may be utilized for prolonged residence of an article internally of the subject and/or for inhibition of mobility of the article internally of the subject.

The mucoadhesive portion may comprise any suitable mucoadhesive material. Non-limiting examples of suitable mucoadhesive materials include polymers such as poly(vinyl alcohol), hydroxylated methacrylate, and poly(methacrylic acid), polyacrylates (e.g., polyacrylic acid, thiolated poly(acrylic acid), Carbopol®), cyanoacrylates, sodium carboxymethylcellulose, hyaluronic acid, hydroxypropylcellulose, polycarbophil, chitosan, mucin, alginate, xanthan gum, gellan, poloxamer, celluloseacetophthalate, methyl cellulose, hydroxy ethyl cellulose, poly(amidoamine) dendrimers, poly(dimethyl siloxane),poly(vinyl pyrrolidone), polycarbophil, combinations thereof, and copolymers thereof.

In some embodiments, the presence of an omniphobic portion adjacent (e.g., directly adjacent) the mucoadhesive portion increases the retention time of the article relative to the a mucoadhesive portion alone. Without wishing to be bound by theory, the omniphobic portion reduces adhesion and/or fouling of the article such that the mucoadhesive portion maintains adhesion (e.g., to a location internal of a subject).

In some embodiments, an article comprising an omniphobic portion and a mucoadhesive portion may have a particular retention time. That is to say, in some embodiments, the mucoadhesive portion may adhere to a substrate (e.g., a surface of tissue located internal to a subject) for a relatively long amount of time. In some embodiments, the retention time of the mucoadhesive portion (of an article comprising a mucoadhesive portion and an omniphobic portion) is at least about 10 minutes, at least about 15 minutes, at least about 20 minutes, at least about 30 minutes, at least about 45 minutes, at least about 60 minutes, at least about 90 minutes, at least about 120 minutes, or at least about 240 minutes. In certain embodiments, the retention time of the mucoadhesive portion (of an article comprising a mucoadhesive portion and an omniphobic portion) is less than or equal to about 360 minutes, less than or equal to about 240 minutes, less than or equal to about 120 minutes, less than or equal to about 90 minutes, less than or equal to about 60 minutes, less than or equal to about 45 minutes, less than or equal to about 30 minutes, less than or equal to about 20 minutes, or less than or equal to about 15 minutes. Combinations of the above referenced ranges are also possible (e.g., at least about 10 minutes and less than or equal to 360 minutes). Other ranges are also possible.

Retention time of an article comprising an omniphobic portion and a mucoadhesive portion may be determined as described above in the context of the retention time of the omniphobic portion, such that a surface of the mucoadhesive portion is now placed in direct contact with the fixed mucosal porcine intestinal tissue (and the omniphobic portion is oriented away from the tissue).

In some embodiments, the articles described herein may be fabricated, for example, using soft lithography and/or imprinting. In an exemplary embodiment, a polydimethylsiloxane master mold with microposts from a natural lotus leaf pattern is contacted with a Janus article having an omniphobic portion (e.g., comprising cellulose acetate powder) and a mucoadhesive portion (e.g., Carbopol® powder) compressed together by a tablet-press. In some embodiments, the microposts from the lotus leaf are replicated onto the omniphobic portion via reverse imprinting to form a textured surface. In certain embodiments, the textured omniphobic portion is fluorinated. In some embodiments, the textured omniphobic portion is coated with a lubricant.

Other methods of forming the articles described herein are also possible and those skilled in the art would be capable of selecting suitable methods based upon the teachings of this specification.

The articles and compositions described herein may be used in a wide range of applications, including imaging and diagnostic electronics such as biosensors, tissue engineering, biomedical implants, as well as dosage formulations for various administration routes, including nasal, ocular, vaginal, and oral drug-delivery. In some embodiments, the articles described herein may be used orally administered drug-delivery systems (e.g., for prolonging of gastrointestinal (GI) retention time and/or provide controlled rate of drug release in a targeted region). Advantageously, articles with increased retention times may allow for rapid absorption and enhanced penetration of drugs as well as improved drug bioavailability, which could, for example, help reduce the frequency of drug administration. In an exemplary embodiment, the article may be adhered to the surface of the skin.

The articles described herein may be administered to a location internal a subject by any suitable method including, but not limited to, oral, rectal, and vaginal administration. In certain embodiments, the articles described herein may be implanted (e.g., via surgery) to a location internal of a subject.

In certain embodiments, the article is constructed and arranged to release an active substance from the article. In certain embodiments, an active substance is designed to be released from the omniphobic portion and/or the mucoadhesive portion and/or one or more additional non-omniphobic materials disposed between the mucoadhesive portion. Such embodiments may be useful in, for example, the context of drug delivery. In other embodiments, the active substance is permanently affixed to the omniphobic portion and/or the mucoadhesive portion. Such embodiments may be useful in, for example, molecular recognition and purification contexts.

In some embodiments, the active substance is a radiopaque material such as tungsten carbide or barium sulfate.

In certain embodiments, the active substance is a therapeutic agent. As used herein, the term “therapeutic agent” or also referred to as a “drug” refers to an agent that is administered to a subject to treat a disease, disorder, or other clinically recognized condition, or for prophylactic purposes, and has a clinically significant effect on the body of the subject to treat and/or prevent the disease, disorder, or condition. Therapeutic agents include, without limitation, agents listed in the United States Pharmacopeia (USP), Goodman and Gilman's The Pharmacological Basis of Therapeutics, 10th Ed., McGraw Hill, 2001; Katzung, B. (ed.) Basic and Clinical Pharmacology, McGraw-Hill/Appleton & Lange; 8th edition (Sep. 21, 2000); Physician's Desk Reference (Thomson Publishing), and/or The Merck Manual of Diagnosis and Therapy, 17th ed. (1999), or the 18th ed (2006) following its publication, Mark H. Beers and Robert Berkow (eds.), Merck Publishing Group, or, in the case of animals, The Merck Veterinary Manual, 9th ed., Kahn, C. A. (ed.), Merck Publishing Group, 2005. In some embodiments, the therapeutic agent may be selected from “Approved Drug Products with Therapeutic Equivalence and Evaluations,” published by the United States Food and Drug Administration (F.D.A.) (the “Orange Book”). In some cases, the therapeutic agent is one that has already been deemed safe and effective for use in humans or animals by the appropriate governmental agency or regulatory body. For example, drugs approved for human use are listed by the FDA under 21 C.F.R. §§330.5, 331 through 361, and 440 through 460, incorporated herein by reference; drugs for veterinary use are listed by the FDA under 21 C.F.R. §§500 through 589, incorporated herein by reference. All listed drugs are considered acceptable for use in accordance with the present invention. In certain embodiments, the therapeutic agent is a small molecule. Exemplary classes of agents include, but are not limited to, analgesics, anti-analgesics, anti-inflammatory drugs, antipyretics, antidepressants, antiepileptics, antipsychotic agents, neuroprotective agents, anti-proliferatives, such as anti-cancer agents (e.g., taxanes, such as paclitaxel and docetaxel; cisplatin, doxorubicin, methotrexate, etc.), antihistamines, antimigraine drugs, hormones, prostaglandins, antimicrobials (including antibiotics, antifungals, antivirals, antiparasitics), antimuscarinics, anxioltyics, bacteriostatics, immunosuppressant agents, sedatives, hypnotics, antipsychotics, bronchodilators, anti-asthma drugs, cardiovascular drugs, anesthetics, anti-coagulants, inhibitors of an enzyme, steroidal agents, steroidal or non-steroidal anti-inflammatory agents, corticosteroids, dopaminergics, electrolytes, gastro-intestinal drugs, muscle relaxants, nutritional agents, vitamins, parasympathomimetics, stimulants, anorectics and anti-narcoleptics. Nutraceuticals can also be incorporated. These may be vitamins, supplements such as calcium or biotin, or natural ingredients such as plant extracts or phytohormones.

In another embodiment, the therapeutic agent is an immunosuppressive agent. Exemplary immunosuppressive agents include glucocorticoids, cytostatics (such as alkylating agents, antimetabolites, and cytotoxic antibodies), antibodies (such as those directed against T-cell recepotors or I1-2 receptors), drugs acting on immunophilins (such as cyclosporine, tacrolimus, and sirolimus) and other drugs (such as interferons, opioids, TNF binding proteins, mycophenolate, and other small molecules such as fingolimod).

In a further embodiment, the active substance is used to prevent restenosis. Exemplary agents include sirolimus (rapamycin), everolimus, zotarolimus, biolimus A9, cyclosporine, tranilast, paclitaxel and docetaxel.

In a further embodiment, the active substance is an antimicrobial agent. Exemplary antimicrobials include antibiotics such as aminoglycosides, cephalosporins, chloramphenicol, clindamycin, erythromycins, fluoroquinolones, macrolides including fidaxomicin and rifamycins such as rifaximin, azolides, metronidazole, penicillins, tetracyclines, trimethoprim-sulfamethoxazole, oxazolidinone such as linezolid, and glycopeptides such as vancomycin. Other antimicrobial agents include antifungals such as antifungal polyenes such as nystatin, amphotericin, candicidin and natamycin, antifungal azoles, allylamine antifungals and echinocandins such as micafungin, caspofungin and anidulafungin.

In some embodiments, the therapeutic agent is a small molecule drug having molecular weight less than about 2500 Daltons, less than about 2000 Daltons, less than about 1500 Daltons, less than about 1000 Daltons, less than about 750 Daltons, less than about 500 Daltons, less or than about 400 Daltons. In some cases, the therapeutic agent is a small molecule drug having molecular weight between 200 Daltons and 400 Daltons, between 400 Daltons and 1000 Daltons, or between 500 Daltons and 2500 Daltons.

The active substance may be associated with the omniphobic portion and/or the mucoadhesive portion and present in the article in any suitable amount. In some embodiments, the additive is present in the article an amount ranging between about 0.01 wt % and about 50 wt % versus the total article weight. In some embodiments, the active substance is present in the article in an amount of at least about 0.01 wt %, at least about 0.05 wt %, at least about 0.1 wt %, at least about 0.5 wt %, at least about 1 wt %, at least about 2 wt %, at least about 3 wt %, at least about 5 wt %, at least about 10 wt %, at least about 20 wt %, at least about 30 wt %, at least about 40 wt % versus the total article weight. In certain embodiments, the active substance is present in the composition in an amount of less than or equal to about 50 wt %, less than or equal to about 40 wt %, less than or equal to about 30 wt %, less than or equal to about 20 wt %, less than or equal to about 10 wt %, less than or equal to about 5 wt %, less than or equal to about 3 wt %, less than or equal to about 2 wt %, less than or equal to about 1 wt %, less than or equal to about 0.5 wt %, less than or equal to about 0.1 wt %, or less than or equal to about 0.05 wt %. Combinations of the above-referenced ranges are also possible (e.g., between about 0.01 wt % and about 50 wt %). Other ranges are also possible.

As described above, in some embodiments, the composition includes an active substance associated with the omniphobic portion and/or a non-omniphobic portion. In some cases, the active substance is associated with the omniphobic portion and/or a non-omniphobic portion such that the active substance is embedded within the omniphobic portion and/or a non-omniphobic portion. In some embodiments, the active substance is associated with the omniphobic portion and/or a non-omniphobic portion via formation of a bond, such as an ionic bond, a covalent bond, a hydrogen bond, Van der Waals interactions, and the like. The covalent bond may be, for example, carbon-carbon, carbon-oxygen, oxygen-silicon, sulfur-sulfur, phosphorus-nitrogen, carbon-nitrogen, metal-oxygen, or other covalent bonds. The hydrogen bond may be, for example, between hydroxyl, amine, carboxyl, thiol, and/or similar functional groups.

In some embodiments, the active substance is present in a cavity within the article. For example, in some embodiments, the article comprises an omniphobic portion at least partially encapsulating a non-omniphobic portion (e.g., a capsule) comprising the active substance (e.g., disposed within the capsule).

In some embodiments, the article is provided as a kit to an end-user.

### EXAMPLES

The following examples are intended to illustrate certain embodiments of the present invention, but do not exemplify the full scope of the invention.

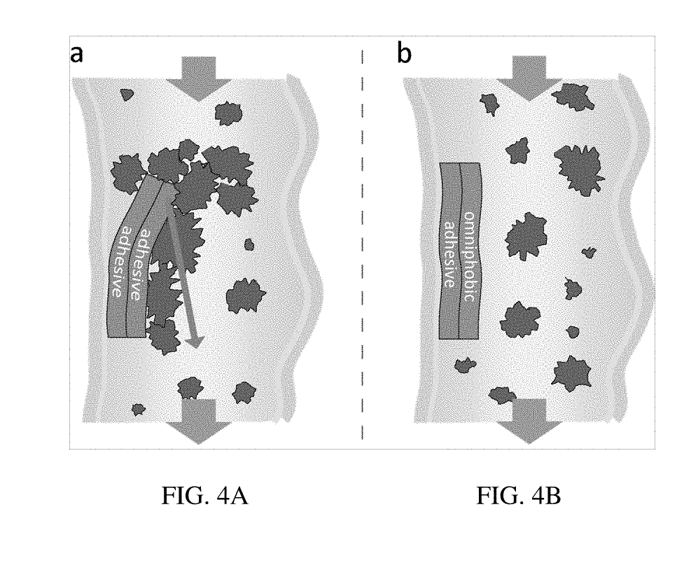

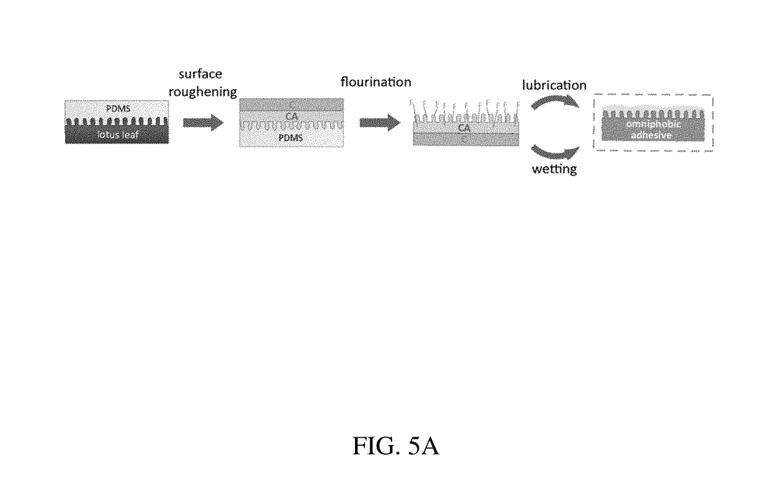

A Janus device was developed including an omniphobic side (portion) and an opposite mucoadhesive side (portion). This system enabled repulsion of a food and fluid stream by the luminal-facing omniphobic side and may allow attachment to the GI mucosa by the mucoadhesive side. FIG. 4A is an illustration of a mucoadhesive article without an omniphobic portion. FIG. 4B is an illustration of an article as described herein comprising a mucoadhesive portion and an omniphobic portion resistant to adhesion and/or fouling by flowing foodstuffs and other bodily fluids.

Carbopol®, a commercial mucoadhesive polymer that shows generally strong adhesion when wetted, was used as the mucoadhesive side. The omniphobic side was fabricated using an adapted version of the Slippery Liquid-Infused Porous Surface (SLIPS) system. Bioinspired soft lithography that is facile and low-cost was incorporated to replicate the patterned micro/nanostructures of a natural lotus leaf onto the omniphobic side. The morphology of the modified surfaces was visualized by scanning electron microscopy (SEM). Omniphobicity and mucoadhesion of the surfaces were characterized by static contact angle goniometry with various liquids and also by detachment tests. Protein adsorption studies were conducted to confirm protection and anti-fouling of the omniphobic side. Ex vivo dislodgement evaluation, using porcine intestinal tissues and simulated fluid with foodstuffs, demonstrated extended retention of the dual-sided Janus device compared to non-Janus devices. With prolonged retention in the GI tract, the engineered Janus device has significant potential to reduce the frequency of drug administration and therefore promote medication compliance.

As schematically depicted in FIG. 5A, a strategy to manufacture the double-sided Janus device was developed. The Janus device was constructed based on a dual-layered thin sheet, where the powder forms of Carbopol® polymer and cellulose acetate (CA) polymer (in 1:1 ratio) were tablet-pressed, in the manner of one layer on top of the other. Then, the CA side was modified with the omniphobic coating through a three-step process: surface roughening, fluorination, and lubrication. Firstly, for surface roughening, a biologically inspired soft lithography process was employed to produce an artificial polymer membrane that emulates the morphology of a natural lotus leaf. Specifically, a polydimethylsiloxane (PDMS) master mold was created, replicating the microscopic pillar structures from a fresh lotus leaf. This master mold served as an inexpensive template for top-down imprint lithography with acetone-wetted CA polymer membrane. Subsequently, the patterned CA membrane was chemically functionalized via vapor-phase fluorination with perfluorinated silane and then lubricated with a biocompatible, medical-grade perfluorocarbon liquid. Thus, the lubricating fluid became locked within the covalently-tethered fluorinated microposts through, for example, chemical affinity. At completion of the fabrication process, the CA side displayed omniphobic properties and the Carbopol® layer exhibited mucoadhesive properties upon wetting.

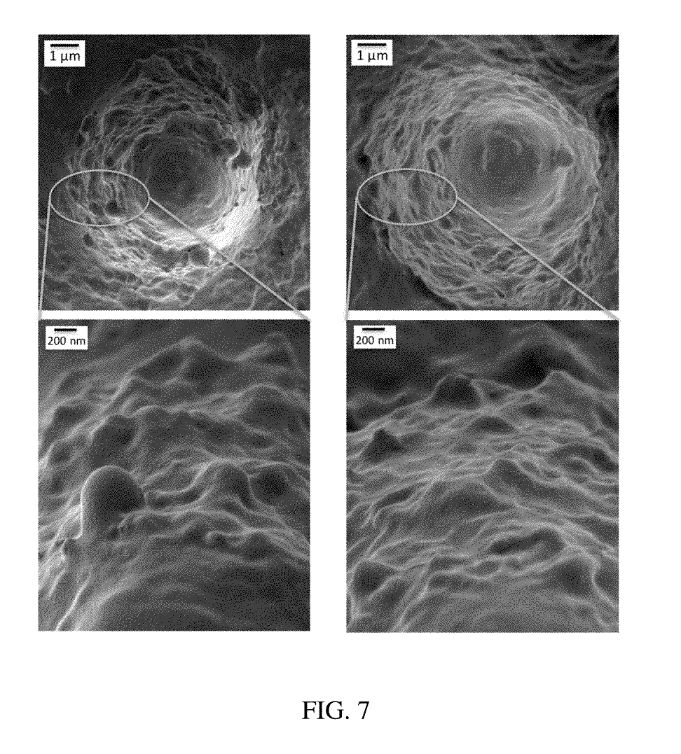

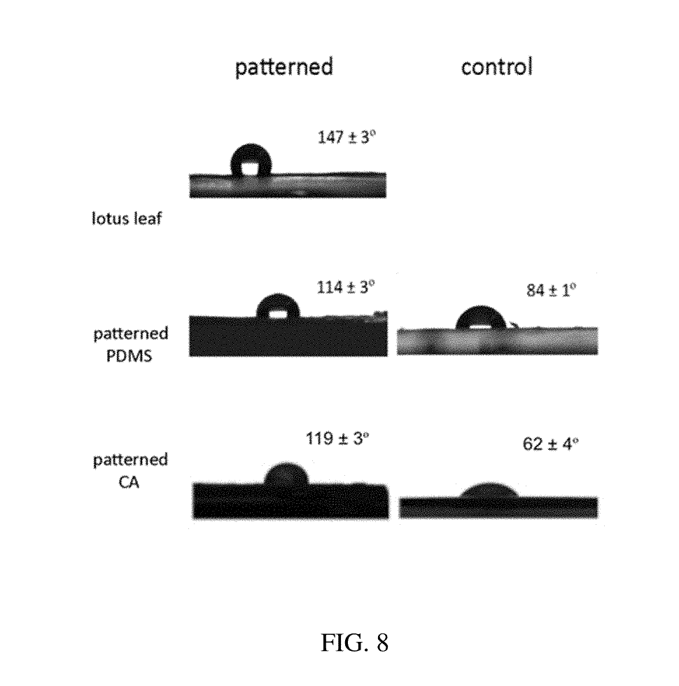

For evaluation of the surface roughening with soft lithography process, SEM was used to examine the quality of the replicated microposts. As shown in FIG. 5B, low and high magnification SEM images showed that the microposts were effectively translated without damages or any significant loss in length, with the height of ˜10 μm maintained throughout the molding process. Moreover, nano-scale roughening was observed on the replicated surface, recapitulating the nano-protrusions on a natural lotus leaf and further contributing to the hydrophobic properties (FIG. 7). As shown in FIG. 8, the surface features were characterized by static contact angle analysis with water. In comparison to the related planar surfaces, the contact angles of the patterned surfaces increased by about 30° for PDMS and 57° for CA. The increases in the contact angles confirmed successful generation of hydrophobic surfaces via surface roughening with micro-scale and nano-scale structures. The incorporation of the lotus leaf based soft lithography offered an attractive, low-cost method to fabricate hydrophobic surfaces in a rapid manner.

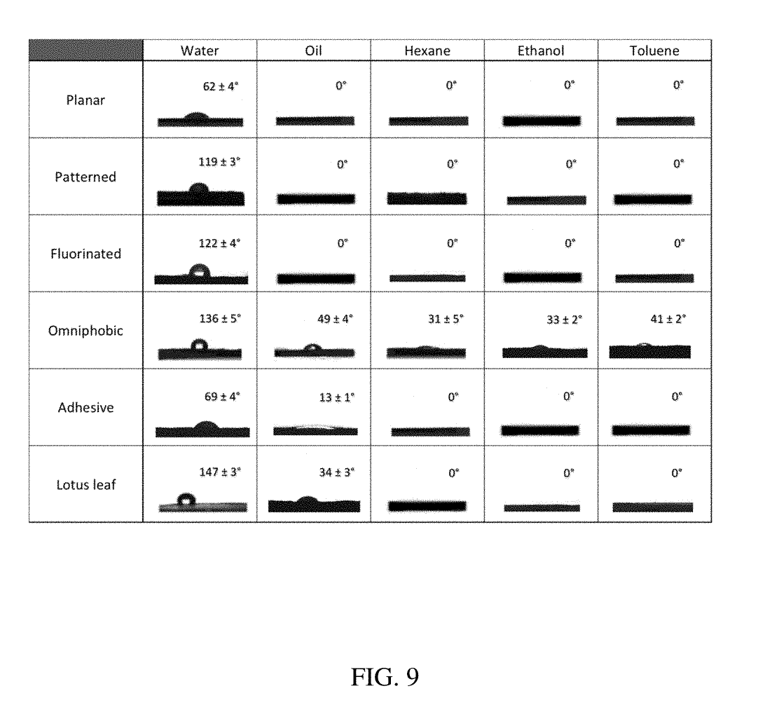

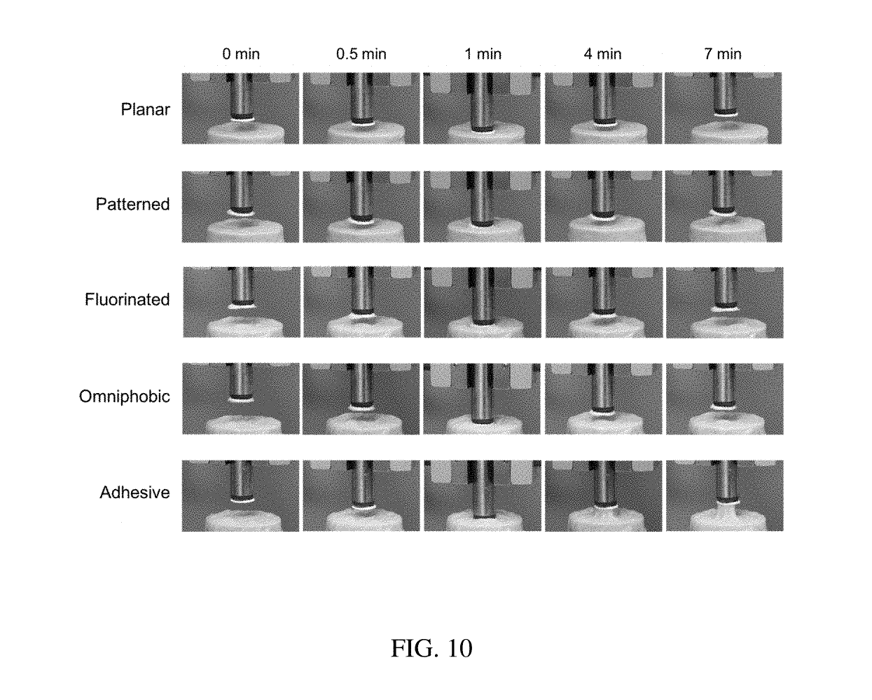

Omniphobicity of the CA surface was confirmed through static contact angle goniometry using a range of non-organic and organic liquids (water, hexane, and vegetable oil in FIG. 5C and additional solvents in FIG. 9). For the planar reference surfaces, θ_{static, water}=62±4°, θ_{static, hexane}=0°, and θ_{static, oil}=0°. For the patterned surfaces with replicated microposts, θ_{static, water}=119±3° and the contact angles for hexane and oil were 0°. The low water wettability confirmed the expected hydrophobicity from the surface roughening through micro/nanostructures, yet the patterned surface remained highly wettable to other liquids. For the omniphobic surfaces with morphological and chemical modifications, the water contact angle further increased to 136±5°, and the hexane and oil contact angles were no longer 0° (θ_{static, hexane}=31±5° and θ_{static, oil}=49±4°. Thus, omniphobicity was attained as the fabricated surface effectively prevented wetting by water as well as by low-surface-tension liquids.

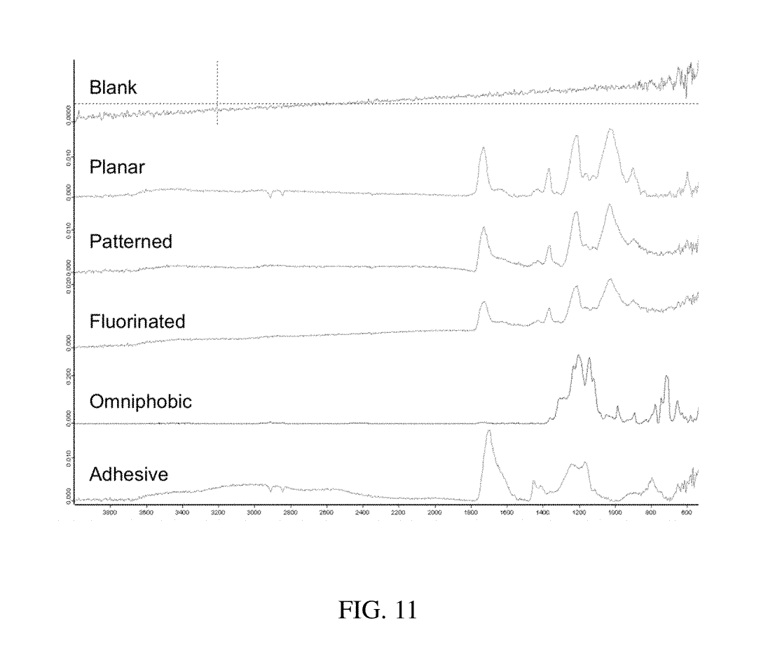

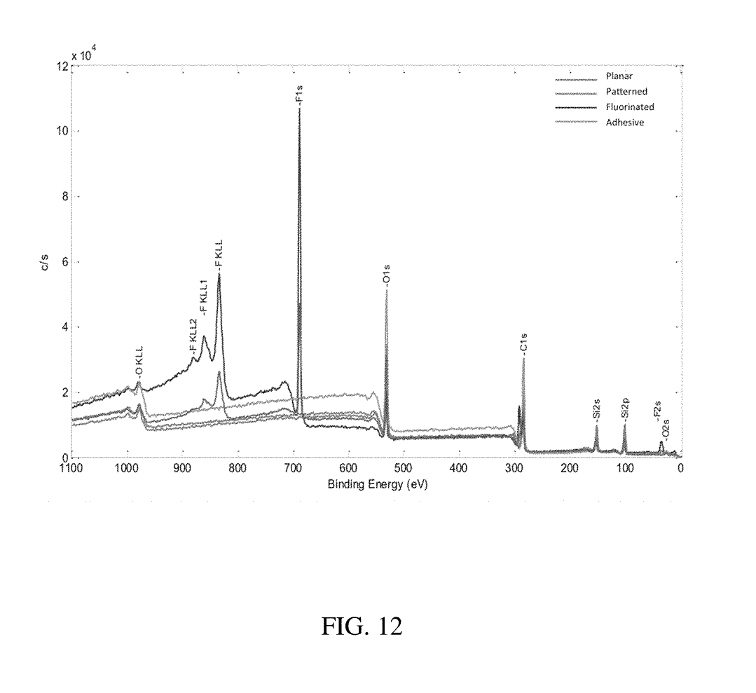

In FIG. 5D, to demonstrate mucoadhesion on the Carbopol® side, detachment tests were conducted using porcine intestinal mucosa (full time-lapse photography is shown in FIG. 10). An external force of 0.5 N for a contact time of 60 seconds was applied onto each surface as the membrane was pressed down into the tissue and then lifted to examine whether the membrane adhered to the mucosa. In accordance to the manufacturing method in FIG. 5A, the following five membranes were examined: planar CA surface, patterned CA surface with the replicated microposts from the lotus leaf, fluorinated CA surface with the replicated microposts, omniphobic CA surface with fluorinated and lubricated microposts, and adhesive wetted Carbopol® surface. All of the CA membranes—planar, patterned, fluorinated, and omniphobic—manifested no significant adhesion to the mucosa. In contrast, the Carbopol® membrane when wetted readily demonstrated strong mucoadhesive behavior. Further characterization by infrared spectroscopy (IR) (FIG. 11) and X-ray photoelectron spectroscopy (XPS) (FIG. 12) illustrates differences in the chemical compositions of the modified membranes, and is summarized in Table 1.

TABLE 1

| | C 1s | O 1s | Si 2p | F 1s |
|---|---|---|---|---|
| Planar | 49.87% | 29.84% | 20.29% | — |
| Patterned | 53.23% | 29.64% | 17.13% | — |
| Fluorinated | 38.75% | 9.88% | 4.00% | 47.38% |
| Adhesive | 60.01% | 33.71% | 6.28% | — |

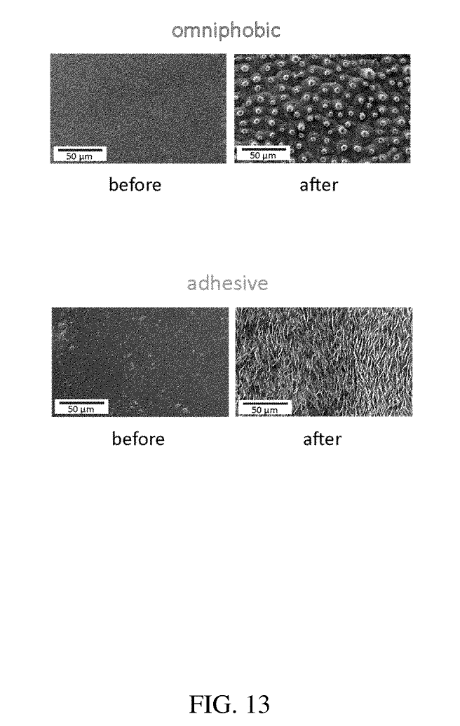

The chemical differences were generally consistent with the surface modifications, where morphological changes with no chemical differences and fluorination with increased presence of tethered fluorine were confirmed. The SEM images in FIG. 13 show the morphological modifications from the initial planar surfaces of CA and Carbopol® to the fabricated surfaces with omniphobicity and mucoadhesiveness, respectively.

The contact angle goniometry studies and the detachment tests confirmed robust omniphobicity from the CA side and strong mucoadhesiveness from the Carbopol® side. Such biomimetic methodology for manufacturing the Janus device offers many favorable features, especially for scale-up and industrial applications: including inexpensive equipment, simple chemical procedure, and short fabrication time. Moreover, this manufacturing approach has the capacity to allow tunable drug-loading into the polymer during the tablet-pressing step for drug-delivery.

The modified surfaces were exposed to fluorescently-labeled bovine serum albumin (BSA) to test their protection from biofouling. FIG. 6A shows fluorescence microscopy images of the five modified surfaces—planar CA, patterned CA, fluorinated CA, omniphobic CA, and adhesive Carbopol®—after incubation with BSA for 24 hours. The omniphobic coating on the CA surface significantly reduced adsorption of protein, shown by the dramatic darkening of fluorescence. FIG. 6B shows a plot of the mean fluorescence intensities that were calculated to quantify the protein adsorbed on the surfaces. Compared to the other four membranes, the omniphobic surface demonstrated reduced amount of protein adsorbed by about 11-17 fold. Protein adsorption studies confirmed protection and anti-fouling of the omniphobic side at neutral pH. Furthermore, for protection in acidic environment of the GI tract, enteric coatings can be incorporated to the device to enable intestinal delivery.

Using the ex vivo flow model outlined in FIG. 6C and described in more detail below, retention for three different types of fabricated devices (omniphobic|adhesive, omniphobic|omniphobic, adhesive|adhesive) was assessed by measuring their dislodgement times on the excised porcine intestinal tissues. Janus devices along with bi-layered adhesive and bi-layered omniphobic non-Janus systems were evaluated and compared. The retention model, designed to mimic the physiological environment of the human's GI system, was irrigated with a simulated fed-state fluid. The irrigation media consisted of fed-state simulated intestinal fluid (FeSSIF, pH ˜5.6) mixed with EnsurePlus® (in a ratio of 1:4). EnsurePlus® (pH ˜6.6) is a commercial shake that has previously been used to represent human fed gastric state, and it is composed of 29% lipids, 54% carbohydrates, and 17% proteins. To the fluid stream, solid foodstuffs (bread and rice pieces) were also added to better approximate the GI interactions and to demonstrate potential fouling on the administered devices. Porcine intestinal tissue was chosen as the substrate (e.g., pigs have intestinal anatomy and mucus conditions similar to humans).

In FIG. 6E, the time-lapse photography example collected from one of the seven replicate experiments illustrated improved retention performance of the Janus device over the non-Janus device with dual-sided adhesive. As the simulated food stream flowed over the administered devices, the Janus device (left) and the non-Janus device (right) were differentiated by the presence or absence of foodstuffs fouling on the outward surfaces of the devices (FIG. 6F). For the Janus device, the omniphobic membrane minimized any undesirable interaction with the foodstuffs and the fluid stream. By contrast, the non-Janus device with the adhesive side facing outward accumulated foodstuffs on its surface, creating resistance against the fluid flow. Consequently, in terms of the retention times shown in FIG. 6D, the Janus device was retained on the mucosa for a significantly longer period of time in comparison to both non-Janus devices. While the non-Janus devices became dislodged after a few seconds, dual-adhesive devices at ˜7 seconds and dual-omniphobic devices at ˜1 second, the Janus devices remained adherent to the mucosa for more than 10 minutes, at which time the measurement was stopped. Dual-omniphobic devices were non-adherent and therefore manifested in rapid transit times. Devices with dual-adhesive layers were retained, though subsequently dislodged, which may be due to the increasing fouling on the luminal side of the device leading to greater interaction with the continuous fluid flow.

Materials: Nanopure water was used for all aqueous sample preparations and experiments (Millipore Milli-Q Reference Ultrapure Water Purification System, 18.2 MΩ·cm). Acetone (AR, ACS grade) was purchased from Macron Fine Chemicals (Center Valley, Pa.). For the molding method, Sylgard 184 Silicone Elastomer Kit was used with the base and the curing agent purchased from Dow Corning (Midland, Mich.). Fresh lotus leaves were acquired from a local company called Wonderful Water Lilies (Sarasota, Fla.). Cellulose acetate (MW ˜30,000) was purchased from Sigma-Aldrich (St. Louis, Mo.). For constructing omniphobic membranes, heptadecafluoro-1,1,2,2-tetrahydrodecyl trichlorosilane was purchased from Gelest, Inc. (Morrisville, Pa.) and perfluorodecalin was purchased from Sigma-Aldrich. For adhesive membranes, Carbopol 934 was purchased from Lubrizol (Wickliffe, Ohio). For contact angle analysis, vegetable oil was purchased from a local store and hexane (Macron Fine Chemicals, AR, ACS grade), ethanol (Koptec, King of Prussia, Pa., 200 proof, 99.5%), and toluene (Sigma-Aldrich, anhydrous, 99.8%) were used. Albumin from bovine serum (BSA)-Alexa Fluor 488 conjugate and phosphate-buffered saline (PBS) were purchased from Thermo Fisher (Waltham, Mass.). Potassium chloride (KCl), acetic acid, sodium taurocholate, lecithin, and sodium hydroxide (NaOH) were purchased from Sigma-Aldrich. Fed-state simulated intestinal fluid (FeSSIF) was made using 15.2 g L⁻¹ of KCl, 8.65 g L⁻¹ of acetic acid, 15 mM of sodium taurocholate, and 3.75 mM of lecithin, and was adjusted to pH ˜5.6 by NaOH and water. EnsurePlus (Abbott Laboratories B.V., Zwolle, the Netherlands) was purchased from a local store. All chemicals were used as received unless otherwise specified. Pig tissues were procured from a slaughterhouse (Research 87) in Massachusetts. All tissues were collected within 2 hours of the animal being sacrificed and kept at 4° C. for as long as 7 days.

Manufacturing of lotus leaf polydimethylsiloxane (PDMS) mold: The acquired fresh lotus leaf was cut into a small piece, rinsed with nanopure water, and dried with nitrogen gas. The leaf piece was glued down to a plate with the upper leaf side facing outward. PDMS pre-polymer solution was made with 10:1 ratio of Sylgard 184 Silicone Elastomer base and curing agent. The PDMS solution was placed in a vacuum desiccator for approximately an hour to eliminate air bubbles. The solution was poured onto the plate with the leaf taped down on the bottom. The mold was placed in a vacuum oven at 40° C. overnight. Then the mold was placed at room temperature for an hour to cool down before it was peeled off from the leaf.

Fabrication of Janus device: In 1:1 ratio of ˜300 mg each, the powder forms of Carbopol polymer and of cellulose acetate (CA) polymer were tablet-pressed at 20 MPa, one layer on top of the other, into a dual-layered thin tablet. YLJ-24T Desk-Top Powder Presser purchased from MTI Corporation was used. A droplet of acetone was pipetted onto the surface of the CA layer. The tablet was quickly pressed onto the PDMS lotus leaf master mold with the wetted CA layer facing down onto the mold. The tablet was pressed down for approximately 15 minutes until the acetone evaporated away, and then the tablet was detached from the PDMS mold. With the CA side facing up, the tablet was placed in a vacuum desiccator for overnight with 0.2 mL of heptadecafluoro-1,1,2,2-tetrahydrodecyl trichlorosilane in a glass vial for fluorination. Then the perfluorodecalin was pipetted over the fluorinated CA surface to create a lubricating film locked within the microposts.

Scanning electron microscopy (SEM): The morphology of the fabricated surfaces was observed using a JEOL 5600LV SEM. For nano-scale visualization, a Zeiss Merlin High-resolution SEM was used. Before visualization under SEM, all samples were sputter-coated with carbon using the Hummer 6.2 Sputter Coating System. Samples were cut to be under 0.5 cm² in area and fixed to the aluminum stubs by a double-sided adhesive carbon conductive tape.

Contact angle goniometry: The wetting of the fabricated surfaces was characterized by static contact angle measurements using the Krüss Drop Shape Analyzer DSA100 with the software Drop Shape Analyzer (Matthews, N.C.). Contact angles with various liquids (water, vegetable oil, hexane, ethanol, and toluene) over the sample surface, fixed to lay flat on a horizontal plane, were measured at room temperature. A fixed volume of 250 μL droplet of the chosen liquid was dispensed onto the substrate, and the contact angle made between the line tangent to the liquid droplet and the substrate surface was measured. The macroscopic droplet profile was photographed by a camera installed within the instrument. The mean and the standard deviation values for each surface were calculated and reported from eight measurements.

Detachment tests: A segment of porcine intestinal tissue was placed onto a bottom platform with the mucosal side facing up, and a test membrane was fixed onto the upper platform with the modified side facing down. An external force of 0.5 N for contact time of 60 seconds was applied onto each surface as the membrane was pressed down into the tissue and then lifted up at the rate of 0.5 mm min⁻¹ to examine whether the membrane adhered to the mucosa. Using a digital camera, sequential photographs were collected.

Infrared spectroscopy (IR): IR spectra were recorded on the ALPHA FT-IR Spectrometer (Bruker Corporation) and analyzed using the OPUS v. 6.5.92 software.

X-ray photoelectron spectroscopy (XPS): XPS analysis was performed using the PHI VersaProbe II (Physical Electronics). The instrument, equipped with a monochromatic aluminum X-ray source, was operated with the pass energy of 187.85 eV and chamber pressure under 2×10⁻⁹ Torr during the analysis. Photoelectrons were collected at an angle of 45.0° from the surface normal. Samples were dehydrated through lyophilization overnight. Upon removal from the lyophilizer, samples were transported to the XPS equipment in a vacuum desiccator and analyzed immediately.

Protein adsorption studies: 1 mg/ml BSA-Alexa Fluor 488 conjugate was dissolved in PBS at pH 7.4. Samples of a defined size (0.5 cm²) were incubated in 300 uL of fluorescently-labeled BSA solution for 24 hours at 37 ° C. The samples were rinsed five times with PBS and observed under a fluorescence microscope (EVOS) at 2× magnification. Captured images were analyzed and quantified based on the mean fluorescence intensity using the image-processing software ImageJ (NIH). All intensities were corrected to that emitted from the negative control for each corresponding modified surfaces. The mean and the standard deviation values for each surface were calculated and reported from eight replicates.

Ex vivo studies: The prior tissue flow binding setup was modified as follows for evaluation of the devices. A flow model apparatus (shown in FIG. 6C) was built to examine the retention profiles of the fabricated devices. Excised porcine intestinal tissues were cut into a length of 30 cm and opened to line the slide of the apparatus. With the detachable slide from the apparatus laid flat, a Janus device and a non-Janus device were placed on the tissue, at 22 cm from the bottom of the slide. They were incubated at room temperature for 30 seconds allowing the Carbopol polymer to adhere to the mucosa through hydration. The slide was turned upside down to ensure that the devices had adhered and was put back to the apparatus at a tilt angle of 30°. At room temperature, the fixed mucosal intestinal tissue was continuously flushed with simulated fed-state fluid at 850 mL min⁻¹. The flow rate was selected based on the range of transit times for fluids in the GI tract; with the intestinal transit time for fed-state being approximately 2-3 mL min⁻¹ and the esophageal transit time being around 700-800 mL min⁻¹, a value near the upper boundary was selected to simulate the maximal physiological stress. The simulated fluid consisted of fed-state simulated intestinal fluid (FeSSIF, pH ˜6.8) and EnsurePlus (pH ˜6.6) in a ratio of 1:4 with foodstuffs (15 g/L of bread pieces and 50 g/L of rice) mixed in. The times for dislodgment were documented and compared for the different fabricated devices. Video was recorded with a digital camera and sequential photographs from the video recordings were collected. The retention studies for the three types of fabricated devices (omniphobicladhesive, omniphobiclomniphobic, adhesive|adhesive) were performed in seven replicates each, using fresh intestinal tissue piece at each trial.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

“Microtexture”, as used herein, generally refers to a texture of a surface comprising a plurality of features having a cross-sectional dimension, such as an average cross-sectional dimension, from about 1 micron to about 100 microns, about 1 to about 50 microns, about 1 to about 30 microns, or about 1 micron to about 10 microns. The microtextured features can have any shape.

“Nanotexture,” as used herein, generally refers to a texture of a surface comprising a plurality of features having a cross-sectional dimension, such as an average cross-sectional dimension from about 1 nm up to, but not including, about 1 micron, about 5 nm to about 500 nm, or about 5 nm to about 300 nm. In some embodiments, the plurality of features have an average cross-sectional dimension from about 100 nm to about 300 nm, about 100 nm to about 250 nm, or about 100 nm to about 200 nm.

Any terms as used herein related to shape and/or geometric relationship of or between, for example, one or more articles, structures, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape and/or geometric relationship include, but are not limited to terms descriptive of: shape—such as, round, square, circular/circle, rectangular/rectangle, triangular/triangle, cylindrical/cylinder, elliptical/ellipse, (n)polygonal/(n)polygon, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described.

What is claimed is:

1. An article for introduction internally of a subject, the article constructed and arranged for introduction into and residence internally of the subject, or to exhibit a physiological surface retention time of less than 5 seconds, the article comprising an omniphobic portion for resisting adhesion, to the device, of material internally of the subject.

2. An article for introduction to and residence internally of a subject with resistance to adhesion and/or fouling, to the article, of material internally of the subject, the article comprising:
a mucoadhesive portion for inhibition of mobility of the device internally of the subject, and
a omniphobic portion for resisting adhesion and/or fouling, to the device, of material internally of the subject.

3. An article for introduction to internally of a subject with resistance to adhesion, to the composition, of material internally of the subject, comprising:
a non-omniphobic portion at least partially encapsulated by an omniphobic portion,
wherein the omniphobic portion comprises a polymer having a textured surface and a lubricant disposed on at least a portion of the textured surface.

4. A method of administering an article constructed and arranged for introduction into and residence internally of the subject, or to exhibit a physiological surface retention time of less than 2 seconds, the method comprising:
administering, to the subject, the article comprising an omniphobic portion for resisting adhesion, to the article, of material internally of the subject.

5. An article as in claim 1, wherein the omniphobic portion comprises a polymer having a microtextured and/or nanotextured surface.

6. An article as in claim 1, wherein the omniphobic portion comprises a lubricant disposed on at least a portion of the microtextured and/or nanotextured surface.

7. An article as in claim 1, wherein the article comprises a coating comprising the omniphobic portion.

8. An article as in claim 1, wherein the article comprises a cavity.

9. An article as in claim 8, wherein the cavity comprises at least one therapeutic agent.

10. An article as in claim 5, wherein the polymer is selected from the group consisting of cellulose acetate, cellulose acetate butyrate, cellulose acetate phthalate, hydroxypropyl methyl cellulose, polyester, polyether, polysiloxane, polyamide, polyolefin, polycarbonate, polyketal, polyvinyl alcohol, polyoxetane, polyacrylate, polyanhydride, and polyurethane.

11. An article as in claim 3, wherein the lubricant comprises a fluorinated liquid.

12. An article as in claim 3, wherein the non-omniphobic portion is a mucoadhesive portion.

13. An article as in claim 12, wherein the mucoadhesive portion comprises a mucoadhesive material.

14. An article as in claim 2, wherein the omniphobic portion comprises a polymer having a microtexture and/or nanotextured surface.

15. An article as in claim 2, wherein the omniphobic portion comprises a lubricant disposed on at least a portion of the microtexture and/or nanotextured surface.

16. An article as in claim 1, wherein the article has a retention time of at least 10 minutes.

17. An article as in claim 2, wherein the mucoadhesive portion is directly adjacent the omniphobic portion.

18. An article as in claim 3, wherein the non-omniphobic portion comprises at least one therapeutic agent.
